(19) United States
(12) Patent Application Publication
(10) Pub. No.: US 2025/0075861 A1
(43) Pub. Date: Mar. 6, 2025

(54) TANK HOLDING PORTION STRUCTURE OF VEHICLE

(71) Applicant: HONDA MOTOR CO., LTD., Tokyo (JP)

(72) Inventors: Kiyoshige Saitoh, Tokyo (JP); Shintaro Kani, Tokyo (JP); Hiroyoshi Suzuki, Tokyo (JP)

(21) Appl. No.: 18/823,732

(22) Filed: Sep. 4, 2024

(30) Foreign Application Priority Data
Sep. 6, 2023 (JP) 2023-144817

(51) Int. Cl. F17C 13/08; B60K 15/063; B60K 15/07

(52) U.S. Cl. CPC F17C 13/084; B60K 15/07; B60K 2015/0634; F17C 2201/0104; F17C 2205/0103; F17C 2221/012; F17C 2221/033; F17C 2270/0168

(57) ABSTRACT

This tank holding portion structure of a vehicle which holds a substantially cylindrical tank disposed below a floor panel of a vehicle body includes: a plurality of tank bands which are disposed at a plurality of locations spaced apart from each other in an axial direction of the tank and each of which restrains an outer circumferential surface of the tank; and a plurality of connecting members extending in the axial direction of the tank and connecting the adjacent tank bands to each other on an outer circumferential portion of the tank.

### CROSS-REFERENCE TO RELATED APPLICATION

The present application claims priority based on Japanese Patent Application No. 2023-144817, filed Sep. 6, 2023, the content of which is incorporated herein by reference.

### BACKGROUND OF THE INVENTION

### Field of the Invention

The present invention relates to a tank holding portion structure of a vehicle.

### Description of Related Art

A vehicle that travels using a gas fuel such as hydrogen gas as a fuel is known. In this type of vehicle, a substantially cylindrical tank for storing a gas fuel may be disposed below a floor panel. In this case, the tank is firmly fixed to a frame portion of a vehicle body or the like by various holding means (see, for example, Japanese Patent No. 7237103).

In a tank holding portion structure described in Japanese Patent No. 7237103, tank bands are wound around a plurality of locations spaced apart from each other in an axial direction of the tank, and the outer circumferential surface of the tank is restrained by the tank bands. In this state, the tank bands are each fixed to a vehicle body frame.

### SUMMARY OF THE INVENTION

In the tank holding portion structure described in Japanese Patent No. 7237103, a plurality of tank bands are fixed to the vehicle body frame in a state in which the tank bands restrain the outer circumferential surface of the tank, thereby suppressing shifting and vibration of the tank while a vehicle is traveling. However, in the tank holding portion structure described in Japanese Patent No. 7237103, when a large impact load is input to the vehicle, torsion may occur in a fixing portion of each tank band depending on the input direction and input position of the load. In particular, in the case of this tank holding portion structure, since the plurality of tank bands are individually fixed to the vehicle body frame, it is possible that a torsional stress may be concentrated in some of the tank bands.

An aspect of the present invention is to provide a tank holding portion structure of a vehicle that can suppress torsion of a tank band and a tank when an impact load is input. The present invention will ultimately further improve traffic safety and contribute to the development of a sustainable transportation system.

In order to achieve the above object, a tank holding portion structure of a vehicle according to an aspect of the present invention adopts the following configurations.

(1) According to an aspect of the present invention, there is provided a tank holding portion structure of a vehicle which holds a substantially cylindrical tank (for example, a tank 10 of an embodiment) disposed below a floor panel (for example, a floor panel 2 of an embodiment) of a vehicle body, including: a plurality of tank bands (for example, tank bands 15 of an embodiment) which are disposed at a plurality of locations spaced apart from each other in an axial direction of the tank and each of which restrains an outer circumferential surface of the tank; and a plurality of connecting members (for example, a first connecting member 20A, a second connecting member 20B, and a third connecting member 20C of an embodiment) extending in the axial direction of the tank and connecting the adjacent tank bands to each other on an outer circumferential portion of the tank.

According to the above aspect (1), the plurality of tank bands that restrain the outer circumferential surface of the tank are connected to each other by the plurality of connecting members. For this reason, when an impact load is input to the vehicle, torsion of each tank band is mutually suppressed via the plurality of connecting members. That is, when an impact load is received and a torsional load acts on a part of the tank band, the torsional load is distributed to a plurality of locations of the other tank band via the plurality of connecting members. As a result, the concentration of a torsional stress on a part of the tank band is suppressed.

Furthermore, since the plurality of tank bands are connected at a plurality of locations of a circumferential region of the tank by the connecting members, torsion of the tank bands and the tank can be suppressed over a wide range of the circumferential region of the tank.

(2) In the above aspect (1), each of the tank bands may be formed by connecting a plurality of band element pieces (for example, band element pieces 15a, 15b, and 15c of an embodiment) arranged in an outer circumferential direction of the tank in an annular shape, and the plurality of connecting members may include a first connecting member (for example, a first connecting member 20A of an embodiment) that connects connecting ends of the band element pieces of the adjacent tank bands to each other.

According to the above aspect (2), since the first connecting member connects the connecting ends of the band element pieces of the adjacent tank bands to each other, torsion of each tank band is suppressed by the first connecting member, and rigidity of the connecting ends of the band element pieces is increased by the first connecting member. Therefore, in a case in which the present configuration is adopted, deformation of the connecting ends of the band element pieces during normal use is also suppressed.

(3) In the above aspect (2), a connecting portion of the band element pieces may include a first fixing piece (for example, a first fixing piece 16 of an embodiment) that is fixed to one of the band element pieces, a second fixing piece (for example, a second fixing piece 17 of an embodiment) that is fixed to the other one of the band element pieces, and a spring function component (for example, a guide rod 18 and a compression spring 19 of an embodiment) that connects the first fixing piece and the second fixing piece with spring elasticity, and the first connecting member may connect at least either the first fixing pieces or the second fixing pieces of the adjacent tank bands in the connecting portions of at least some of the band element pieces.

According to the above aspect (3), since the band element pieces of the tank band are connected to each other via the spring function component, the expansion or contraction of the tank due to heat, an increase or decrease in the content quantity, or the like can be allowed by the spring function component. In addition, since at least either the first fixing pieces or the second fixing pieces of the adjacent tank bands are connected by the first connecting member, torsion of each tank band is suppressed and rigidity of the connecting end (the first fixing piece or the second fixing piece) of the band element pieces can be efficiently increased.

(4) In the above aspect (3), the first connecting member may be formed integrally with at least one of the first fixing piece and the second fixing piece.

According to the above aspect (4), since the first connecting member is formed integrally with at least one of the first fixing piece and the second fixing piece, it is possible to improve torsional rigidity of each tank band and rigidity of the connecting ends of the band element pieces while suppressing an increase in the number of components.

(5) In the above aspect (3) or (4), the first connecting member may include a band fixing wall (for example, a band fixing wall 20Aa of an embodiment) that is overlapped and fixed to an outer surface of each of the band element pieces of the adjacent tank bands, and a standing wall (for example, a standing wall 20Ab of an embodiment) that stands up outward from the band fixing wall in a radial direction of the tank, and the spring function component may be connected to the standing wall.

According to the above aspect (5), it is possible to efficiently receive the expansion or contraction load of the spring function component acting between the band element pieces by the standing wall that stands up outward from the band fixing wall of the first connecting member in the radial direction. In addition, since the first connecting member has the band fixing wall that conforms to the outer surfaces of the band element pieces, and the standing wall that is substantially perpendicular to the band fixing wall, rigidity against the torsional load can be further increased. Therefore, in a case in which the present configuration is adopted, torsion of the tank bands and the tank can be more reliably suppressed.

(6) In the above aspect (3), the plurality of connecting members may include a second connecting member (for example, a second connecting member 20B of an embodiment) that connects portions of the band element pieces of the adjacent tank bands other than the connecting ends to each other.

According to the above aspect (6), in the adjacent tank bands, the connecting ends of the band element pieces are connected to each other by the first connecting member, and the portions of the band element pieces other than the connecting ends are connected to each other by the second connecting member. For this reason, in a case in which the present configuration is adopted, it is possible to increase rigidity of a wider region of the circumferential region of each of the plurality of tank bands.

(7) In the above aspect (6), the second connecting member may be formed of a plate-shaped member which substantially conforms to the outer circumferential surface of the tank, and a lightening hole (for example, a lightening hole 20Ba of an embodiment) may be formed at a position on the second connecting member which does not overlap the adjacent tank bands between the tank bands.

According to the above aspect (7), it is possible to increase torsional rigidity of the adjacent tank bands while suppressing an increase in weight by the plate-shaped second connecting member having the lightening hole. In addition, in the plate-like second connecting member in which the lightening hole is formed, it is possible to maintain rigidity against torsion to be high by two sides with the lightening hole interposed therebetween.

(8) In the above aspect (3), the plurality of connecting members may include a pair of third connecting members (for example, a third connecting member 20C of an embodiment) that connect portions of the band element pieces of the adjacent tank bands other than the connecting ends to each other and are each fixed to a first vehicle body frame (for example, a front cross member 4 of an embodiment) and a second vehicle body frame (for example, a rear cross member 5 of an embodiment) which are disposed to be spaced apart from each other in a direction intersecting with the axial direction of the tank.

According to the above aspect (8), the adjacent tank bands are connected to each other by the pair of third connecting members, one of the third connecting members is fixed to the first vehicle body frame, and the other of the third connecting members is fixed to the second vehicle body frame. As a result, torsional rigidity of the adjacent tank bands is increased by the pair of third connecting members, and the tank bands and the tank are fixed to the first vehicle body frame and the second vehicle body frame by the same third connecting members.

(9) In the above aspect (8), the connecting portions of the band element pieces each having the spring function component may be each disposed above and below the pair of third connecting members.

According to the above aspect (9), when the tank expands or contracts due to heat or the like, the spring function components above and below the third connecting members fixed to the vehicle body frame (the first vehicle body frame and the second vehicle body frame) each expand or contract. For this reason, the plurality of tank bands expand or contract more evenly in the circumferential region, and the center of the tank is less likely to move significantly up and down. Therefore, in a case in which the present configuration is adopted, it is possible to stably arrange the tank below the floor panel.

(10) In the above aspect (8), the connecting members other than the pair of third connecting members may be disposed only on a side of a center point (for example, a center point o of an embodiment) of the tank with respect to a straight line (for example, a straight line L1 of an embodiment) connecting end portions of the band fixing portions (for example, band fixing portions 30 of an embodiment) of the pair of third connecting members in a vertical direction.

According to the above aspect (10), the pair of third connecting members are supported by the vehicle body frame (the first vehicle body frame and the second vehicle body frame) with high rigidity. A portion on a side of the center point of the tank has a relatively larger separation distance than a portion on a side opposite to the center point with respect to the straight line connecting the band fixing portions of the pair of third connecting members. In the present configuration, the connecting members other than the third connecting member are disposed only on the side on which the separation distance from the straight line connecting the band fixing portions of the pair of third connecting members is larger. As a result, it is possible to efficiently suppress torsion of the plurality of tank bands and the tank while minimizing an increase in weight due to addition of the connecting member.

According to an aspect of the present invention, since a plurality of tank bands that restrain the outer circumferential surface of a tank are connected to each other by a plurality of connecting members, it is possible to efficiently suppress torsion of the tank bands and the tank when an impact load is input. Therefore, in a case in which a tank holding portion structure of a vehicle according to the present invention is adopted, it is possible to further improve traffic safety and to contribute to the development of a sustainable transportation system.

### BRIEF DESCRIPTION OF THE DRAWINGS

FIG. 1 is a schematic side view of a lower portion of a vehicle in which a tank holding portion structure of an embodiment is adopted.

FIG. 2 is a perspective view of the lower portion of the vehicle in which the tank holding portion structure of the embodiment is adopted.

FIG. 3 is another perspective view of the lower portion of the vehicle in which the tank holding portion structure of the embodiment is adopted.

FIG. 4 is a side view showing the behavior of a tank holding portion of the embodiment.

### DESCRIPTION OF EMBODIMENTS

Hereinafter, an embodiment of the present invention will be described with reference to the drawings. In the following description, front, rear, up, down, left, and right refer to an orientation relative to a forward movement direction of a vehicle unless otherwise specified. Further, an arrow FR indicating a forward direction with respect to the vehicle, an arrow UP indicating an upward direction with respect to the vehicle, and an arrow LH indicating a leftward direction with respect to the vehicle are shown at appropriate places in the drawing.

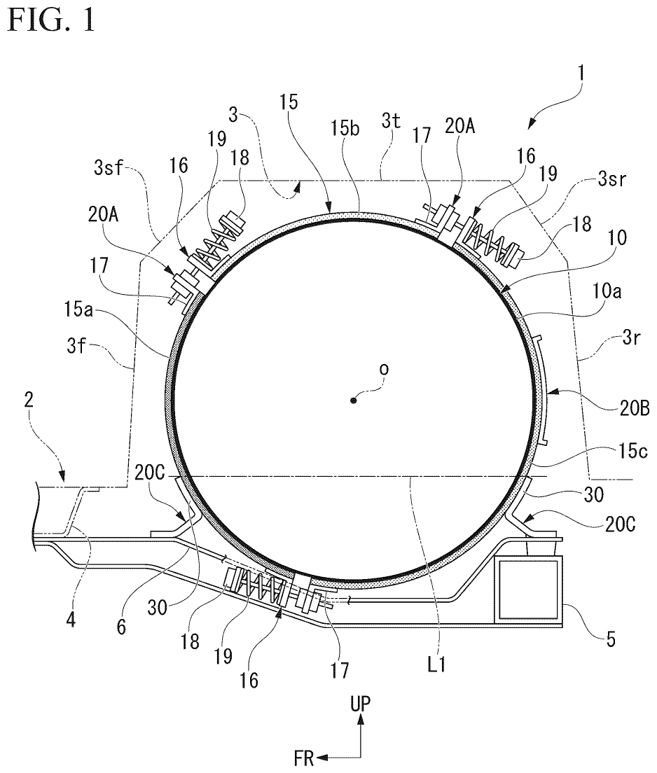

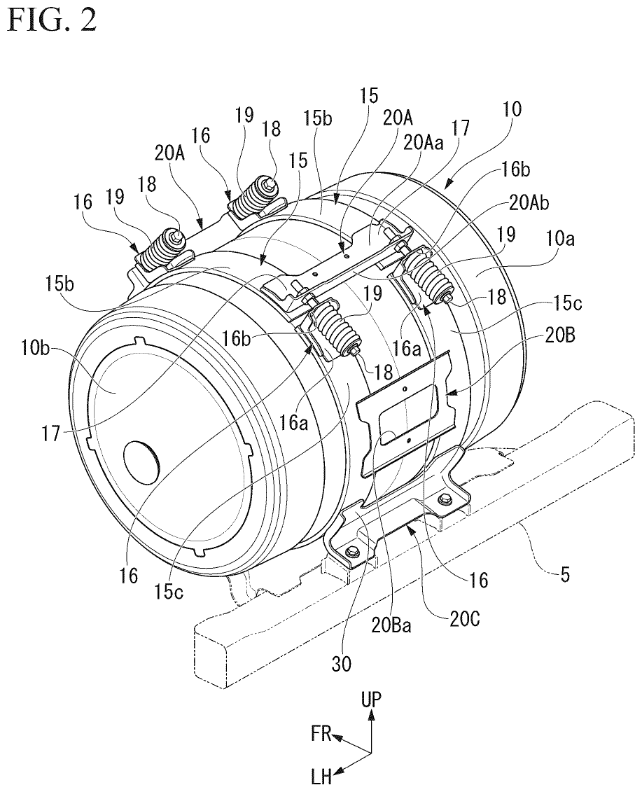

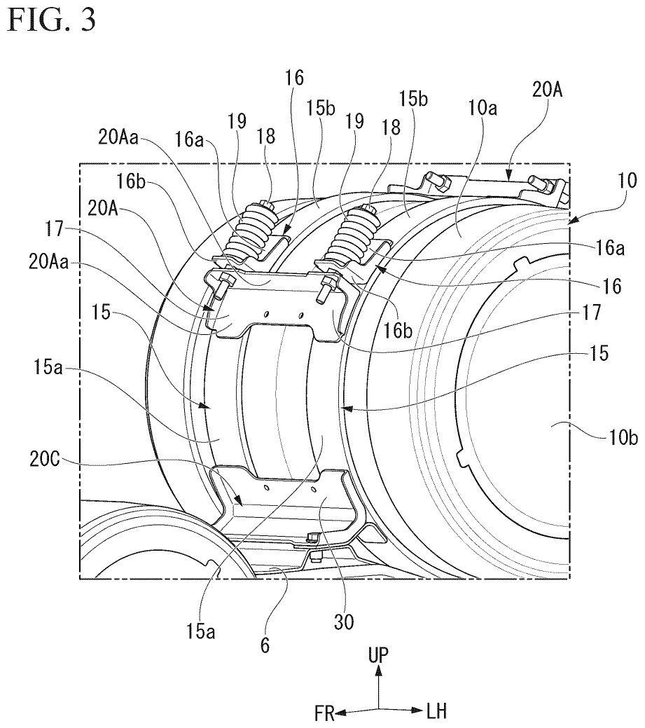

FIG. 1 is a schematic side view of a lower portion of a vehicle 1 in which a tank holding portion structure of the present embodiment is adopted. FIG. 2 is a perspective view of the lower portion of the vehicle 1 in which the same holding portion structure is adopted as seen from a position in front of the vehicle, and FIG. 3 is a perspective view of the lower portion of the vehicle 1 in which the same holding portion structure is adopted as seen from a position behind the vehicle.

As shown in FIG. 1, a floor panel 2 is disposed below the vehicle 1. A tank accommodation groove 3 of which a lower surface is recessed upward is formed on the floor panel 2. The tank accommodation groove 3 is a groove in which the main part of the tank 10 is accommodated from below, and has a substantially constant cross-sectional shape extending in a vehicle width direction. The front-rear width of the tank accommodation groove 3 is set to be wider than the maximum outer diameter of the tank 10. The tank accommodation groove 3 has a front wall 3f and a rear wall 3r that stand vertically upward, and a top wall 3t that connects the upper end portions of the front wall 3f and the rear wall 3r. A front slope portion 3sf that slopes downward and forward from the top wall 3t toward the front wall 3f is provided between the top wall 3t and the front wall 3f, and a rear slope portion 3sr that slopes rearward and downward from the top wall 3t toward the rear wall 3r is provided between the top wall 3t and the rear wall 3r.

The vehicle 1 of the present embodiment is, for example, a gas fuel driven vehicle that travels using a gas fuel such as natural gas or hydrogen gas as a fuel, a fuel cell vehicle that travels using power generated by a fuel gas, or the like. The tank 10 is filled with a high-pressure liquefied fuel or gas. The tank 10 is a substantially cylindrical fuel filling container of which both end portions in an axial direction are sealed. The tank 10 has a cylindrical peripheral wall 10a and end portion walls 10b closing both end portions of the tank 10 in the axial direction.

The floor panel 2 is mounted on side sills (not shown) that are disposed below side portions on both sides of a passenger compartment of the vehicle 1. A front cross member 4 and a rear cross member 5 are disposed in front of and behind the tank accommodation groove 3 of the floor panel 2. The front cross member 4 and the rear cross member 5 extend in the vehicle width direction, and both end portions thereof are connected to the left and right side sills. The tank 10 is disposed below the tank accommodation groove 3 such that the axial direction of the tank 10 is aligned with the vehicle width direction, and, in this state, the front end side of the tank 10 is fixed to the front cross member 4 and the rear end side of the tank 10 is fixed to the rear cross member 5. The front end side of the tank 10 is fixed to the front cross member 4 via a thick lower plate 6 that covers the lower portion of the tank 10.

In the present embodiment, the front cross member 4 constitutes a first vehicle body frame, and the rear cross member 5 constitutes a second vehicle body frame.

A tank holding portion of the present embodiment includes a pair of tank bands 15 that are wrapped around the outer circumferential surface of the tank 10 (the outer surface of the peripheral wall 10a) to restrain the outer circumferential surface of the tank 10, and a first connecting member 20A, a second connecting member 20B, and a third connecting member 20C which connect the pair of tank bands 15 to each other. The first connecting member 20A, the second connecting member 20B, and the third connecting member 20C extend in the axial direction of the tank 10 and constitute connecting members that connect the left and right tank bands 15 to each other. The left and right tank bands 15 are disposed at two positions (two locations) spaced apart from each other in the axial direction of the tank 10, as shown in FIGS. 2 and 3. The left and right tank bands 15 are disposed, for example, at positions that are symmetrical with respect to a midline that passes through the axial midpoint of the tank 10.

Each tank band 15 is formed by connecting three (a plurality of) band element pieces 15a, 15b, and 15c arranged in an outer circumferential direction of the tank 10 in an annular shape. One band element piece 15a is disposed on the front portion side of the tank 10 in a circumferential angle range of approximately 90°, and another band element piece 15b is disposed on the upper portion of the tank 10 closer to the front portion of the tank 10 in a circumferential angle range of approximately 90°. The remaining band element piece 15c is disposed in the remaining circumferential angle range of approximately 180° of the outer circumference of the tank 10. These band element pieces 15a, 15b, and 15c are formed of a plate made of a metal with a substantially constant width. The end portions (the connecting ends) of the adjacent band element pieces 15a, 15b, and 15c are abutted against each other, and the abutted end portions are connected to each other by a connecting portion.

The connecting portion that connects the band element pieces 15a, 15b, and 15c to each other includes a first fixing piece 16 that is fixed to the end portion of one band element piece, a second fixing piece 17 that is fixed to the end portion of the other band element piece, and a guide rod 18 and a compression spring 19 that connect the first fixing piece 16 and the second fixing piece 17 with spring elasticity. In the guide rod 18, one end portion is connected to the second fixing piece 17 and the other end holds the end portion of the compression spring 19 in a state in which the other end has passed through the first fixing piece 16. The compression spring 19 is compressively displaced in accordance with an increase in the separation distance between the band element pieces 15a, 15b, and 15c that are abutted against each other to exert a spring reaction force between the abutted band element pieces 15a, 15b, and 15c in accordance with the compression displacement.

In the present embodiment, the guide rod 18 and the compression spring 19 constitute a spring function component.

The first fixing piece 16 is provided individually on one end side of each of the band element pieces 15a, 15b, and 15c of the left and right tank bands 15. The first fixing piece 16 has a band fixing wall 16a that is overlapped and fixed to the outer surface of the end portion of the corresponding band element piece, and a standing wall 16b that stands up outward from the end portion of the band fixing wall 16a in a radial direction of the tank 10. The band fixing wall 16a and the standing wall 16b have a cross-sectional shape orthogonal to the axial direction of the tank 10 which is formed in a substantially L-shape.

The second fixing piece 17 disposed at the connecting portion on the other end side (the lower side) of the rear lower band element piece 15c is provided individually for each of the left and right tank bands 15. A detailed description of the second fixing piece 17 provided in this portion will be omitted, but the second fixing piece 17 has a band fixing wall and a standing wall (both reference signs are omitted) similar to those of the first fixing piece 16 described above.

On the other hand, the second fixing piece 17 disposed at the connecting portion on the other end side (the upper side) of the front band element piece 15a and the second fixing piece 17 disposed at the connecting portion on the other end side (the rear side) of the upper band element piece 15b are not provided individually for each of the left and right tank bands 15, but are formed integrally with the first connecting member 20A that connects the left and right tank bands 15 to each other. As shown in FIGS. 2 and 3, the first connecting member 20A has a band fixing wall 20Aa that is overlapped and fixed to the outer surface of each of the corresponding band element pieces 15a and 15b of the left and right tank bands 15, and a standing wall 20Ab that stands up outward from the band fixing wall 20Aa in the radial direction of the tank 10. The band fixing wall 20Aa and the standing wall 20Ab have a cross-sectional shape orthogonal to the axial direction of the tank 10 which is formed in a substantially L-shape. The substantially L-shaped cross-sectional shape formed by the band fixing wall 20Aa and the standing wall 20Ab extends continuously in the axial direction of the tank 10 to straddle the corresponding band element pieces of the left and right tank bands 15.

In the present embodiment, the first connecting member 20A is formed integrally with each second fixing piece 17 of the left and right tank bands 15. However, the second fixing pieces 17 of the left and right tank bands 15 and the first connecting member 20A may be formed as separate members, and the first connecting member 20A may be fixed to the second fixed pieces 17 of the left and right tank bands 15 by welding or the like.

In addition, in the case of the present embodiment, the second fixing pieces 17 of the left and right tank bands 15 are connected to each other by the first connecting member 20A, but the first fixing pieces 16 of the left and right tank bands 15 may also be connected to each other by the first connecting member 20A. Furthermore, the first fixing pieces 16 of the left and right tank bands 15 may be connected to each other by the first connecting members 20A, and the second fixing pieces 17 of the left and right tank bands 15 may be connected to each other by the first connecting members 20A. In these cases, the first fixing piece 16 may be formed as an integral component with the first connecting member 20A, or they may be formed as separate components and fixed together by welding or the like.

Here, in each of the left and right tank bands 15, the connecting portion between the front band element piece 15a and the upper band element piece 15b and the connecting portion between the upper band element piece 15b and the rear lower band element piece 15c are disposed to face front and rear corner portions in the tank accommodation groove 3 of the floor panel 2, as shown in FIG. 1. Specifically, the connecting portion on a front upper side is disposed to face the front slope portion 3sf in the tank accommodation groove 3, and the connecting portion on a rear upper side is disposed to face the rear slope portion 3sr in the tank accommodation groove 3. As a result, the first fixing piece 16, the second fixing piece 17, the guide rod 18, the compression spring 19, and the like of each connecting portion are prevented from interfering with the floor panel 2 (the tank accommodation groove 3).

The second connecting member 20B connects portions of the rear lower band element pieces 15c of the left and right tank bands 15 other than the connecting ends to each other. Specifically, as shown in FIGS. 1 and 2, the second connecting member 20B is connected at a position below the upper connecting ends of the left and right band element pieces 15c and facing the rearward of the vehicle. The second connecting member 20B is formed of a plate-shaped member made of a metal which substantially conforms to the outer circumferential surface of the tank 10. The second connecting member 20B is formed with a width (a width in the axial direction of the tank 10) to straddle the outer surfaces of the left and right band element pieces 15c. Furthermore, a substantially rectangular lightening hole 20Ba is formed at a position on the second connecting member 20B which does not overlap the band element pieces 15c between the left and right band element pieces 15c (between the left and right tank bands 15). The lightening hole 20Ba passes through the rectangular plate-shaped second connecting member 20B in a thickness direction. Beam portions (sides) extending in the axial direction of the tank 10 remain on the upper and lower sides from the lightening hole 20Ba of the second connecting member 20B to connect the left and right band element pieces 15c to each other.

Two third connecting members 20C are provided at the front and rear portions of the left and right tank bands 15. The front third connecting member 20C connects portions of the front band element pieces 15a of the left and right tank bands 15 other than the connecting ends to each other and is fixed to the front cross member 4 via the lower plate 6. The rear third connecting member 20C connects portions of the rear lower band element pieces 15c of the left and right tank bands 15 other than the connecting ends to each other and is directly fixed to the rear cross member 5. In the case of the present embodiment, each of the front and rear third connecting members 20C has a cross section orthogonal to the axial direction of the tank 10 which is formed in a substantially V-shape. In each third connecting member 20C, the substantially V-shaped cross section extends continuously in the axial direction. In the third connecting member 20C, since the substantially V-shaped cross section extends in the axial direction, rigidity in bending and torsional directions is increased.

In each of the front and rear third connecting members 20C, one side of the substantially V-shaped cross section is fixed to the outer surfaces of the left and right tank bands 15 by welding or the like. In the present embodiment, the side of the third connecting member 20C that is fixed to the outer surfaces of the left and right tank bands 15 constitutes a band fixing portion 30 of the third connecting member 20C.

As shown in FIG. 1, the front and rear third connecting members 20C are fixedly installed at the front cross member 4 and the rear cross member 5 to be lower than the center point o of the tank 10 (the center point of the peripheral wall 10a of the tank 10) in a state in which the tank 10 is held (restrained) by the left and right tank bands 15. Therefore, the center point o of the tank 10 installed on the vehicle body via the tank holding portion of the present embodiment is disposed above a straight line L1 connecting the upper end portions of the front and rear third connecting members 20C.

In the tank holding portion structure of the present embodiment, in a state in which the front and rear third connecting members 20C are fixed to the vehicle body as described above, the connecting portions of the band element pieces 15a, 15b, and 15c each having the spring function component (the guide rod 18 and the compression spring 19) are each disposed above and below the front and rear third connecting members 20C. Specifically, the connecting portion between the front band element piece 15a and the upper band element piece 15b and the connecting portion between the upper band element piece 15b and the rear lower band element piece 15c are both disposed above the front and rear third connecting members 20C. In addition, the connecting portion between the rear lower band element piece 15c and the front band element piece 15a is disposed below the front and rear third connecting members 20C. For this reason, when the tank 10 expands or contracts in a radial direction due to the influence of heat or the like, the action of each spring function component (the guide rod 18 and the compression spring 19) causes each tank band 15 to expand or contract almost evenly in a circumferential region.

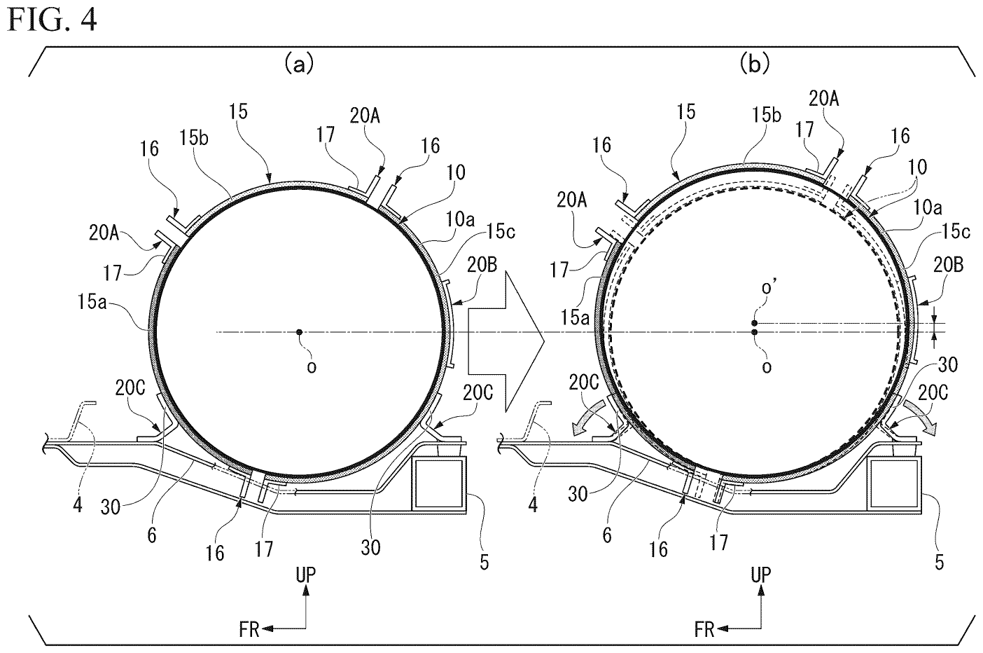

FIG. 4 is a schematic side view showing the deformation behavior of the tank holding portion of the present embodiment. FIG. 4A shows the tank 10 in a state before it is expanded and deformed, and FIG. 4B shows the tank 10 in a state after it is expanded and deformed. The reference sign o′ in FIG. 4B indicates the center point of the tank 10 when the tank 10 is expanded and deformed.

In the holding portion of the tank 10 of the present embodiment, since the connecting portions of the band element pieces 15a, 15b, and 15c are each disposed above and below the front and rear third connecting members 20C, each tank band 15 expands or contracts almost evenly in the circumferential region when the tank 10 is expanded and deformed, as described above. For this reason, the tank 10 does not significantly expand or contract only in an upward direction and the amount of movement of the center point o′ of the tank 10 when the tank 10 expands is kept to be small, as shown in FIG. 4B.

In addition, in the tank holding portion of the present embodiment, the connecting members (the first connecting member 20A and the second connecting member 20B) other than the front and rear third connecting members 20C are disposed only on the side of the center point o of the tank 10 with respect to the straight line L1 connecting the upper end portions of the band fixing portions 30 of the front and rear third connecting members 20C. In other words, no other connecting members are disposed below the band fixing portions 30 of the front and rear third connecting members 20C.

### Effects of the Embodiment

As described above, in the tank holding portion structure of the present embodiment, the left and right tank bands 15 that restrain the outer circumferential surface of the tank 10 are connected to each other by a plurality of connecting members (the first connecting member 20A, the second connecting member 20B, and the third connecting member 20C). For this reason, when an impact load is input to the vehicle 1, torsion of each tank band 15 is mutually suppressed via the plurality of connecting members (the first connecting member 20A, the second connecting member 20B, and the third connecting member 20C).

Specifically, when an impact load is input to the vehicle 1 and a torsional load acts on a part of the tank band 15, the torsional load is distributed to a plurality of portions of the other tank band 15 via the plurality of connecting members (the first connecting member 20A, the second connecting member 20B, and the third connecting member 20C). As a result, a torsional stress is not concentrated on a part of the tank band 15, and torsion of each tank band 15 is suppressed.

Furthermore, in the tank holding portion structure of the present embodiment, since the left and right tank bands 15 are connected at a plurality of locations of the circumferential region of the tank 10 by the connecting members (the first connecting member 20A, the second connecting member 20B, and the third connecting member 20C), torsion of the tank bands 15 and the tank 10 can be suppressed over a wide range of the circumferential region of the tank 10.

Therefore, in a case in which the tank holding portion structure of the present embodiment is adopted, torsion of the tank bands 15 and the tank 10 can be efficiently suppressed when an impact load is input. Therefore, in a case in which the tank holding portion structure of the present embodiment is adopted, it is possible to further improve traffic safety and to contribute to the development of a sustainable transportation system.

In addition, in the tank holding portion structure of the present embodiment, each tank band 15 is constituted by the plurality of band element pieces 15a, 15b, and 15c, and the connecting ends of some of the band element pieces 15a, 15b, and 15c of the two tank bands 15 are connected by the first connecting member 20A. For this reason, torsion of the left and right tank bands 15 is suppressed by the first connecting member 20A, and rigidity of the connecting ends of the band element pieces 15a, 15b, and 15c is increased by the first connecting member 20A. Therefore, in a case in which the present configuration is adopted, it is possible to suppress not only torsion of the left and right tank bands 15 when an impact load is input, but also deformation of the connecting ends of the band element pieces 15a, 15b, and 15c during normal use.

In addition, in the tank holding portion structure of the present embodiment, the connecting portion of the band element pieces 15a, 15b, and 15c includes the first fixing piece 16 that is fixed to one band element piece, the second fixing piece 17 that is fixed to the other band element piece, and the spring function component (the guide rod 18 and the compression spring 19) that connect the first fixing piece 16 and the second fixing piece 17. The second fixing pieces 17 of the left and right tank bands 15 are connected to each other by the first connecting member 20A. For this reason, in a case in which the present configuration is adopted, the expansion or contraction of the tank 10 due to heat, an increase or decrease in content quantity, or the like can be allowed by the function of the spring function component (the guide rod 18 and the compression spring 19), torsion of each tank band 15 can be suppressed, and rigidity of the second fixing pieces 17 of the band element pieces 15a and 15b can be efficiently increased.

In a case in which the first fixing pieces 16 of the left and right tank bands 15 are connected to each other by the first connecting member 20A, rigidity of the second fixing piece 17 can be efficiently increased. In addition, in a case in which the first fixing pieces 16 of the left and right tank bands 15 are connected to each other by the first connecting member 20A and the second fixing pieces 17 of the left and right tank bands 15 are connected to each other by the first connecting member 20A, rigidity of both the first fixing piece 16 and the second fixing piece 17 can be efficiently increased. Furthermore, in the tank holding portion structure of the present embodiment, the first connecting member 20A that connects the second fixing pieces 17 of the left and right tank bands 15 to each other is an integral structure (is integrally formed) with the second fixing pieces 17. For this reason, in a case in which the present configuration is adopted, it is possible to improve torsional rigidity of each tank band 15 and rigidity of the connecting ends of the band element pieces 15a and 15b while suppressing an increase in the number of components.

The same effect can also be obtained in a case in which the first connecting member 20A is an integral structure with the first fixing pieces 16.

In addition, in the tank holding portion structure of the present embodiment, the first connecting member 20A has the band fixing wall 20Aa that is overlapped and fixed to the outer surface of each of the band element pieces 15a and 15b of the left and right tank bands 15, and a standing wall 20Ab that stands up outward from the band fixing wall 20Aa in the radial direction of the tank. The spring function component (the guide rod 18) that is disposed at the connecting portion of the band element pieces 15a, 15b, and 15c is connected to the standing wall 20Ab. For this reason, in a case in which the present configuration is adopted, the standing wall 20Ab that stands up outward from the band fixing wall 20Aa of the first connecting member 20A in the radial direction can efficiently receive the expansion or contraction load of the spring function component acting between the band element pieces 15a, 15b, and 15c.

In addition, since the first connecting member 20A has the band fixing wall 20Aa that conforms to the outer surfaces of the band element pieces 15a and 15b, and the standing wall 20Ab that is substantially perpendicular to the band fixing wall 20Aa, rigidity against the torsional load can be further increased. Therefore, in a case in which the tank holding portion structure of the present embodiment is adopted, torsion of the tank bands 15 and the tank 10 can be more reliably suppressed.

In addition, the tank holding portion structure of the present embodiment includes the second connecting member 20B that connects portions of the band element pieces 15a, 15b, and 15c of the left and right tank bands 15 other than the connecting ends to each other, in addition to the first connecting member 20A. For this reason, in a case in which the present configuration is adopted, it is possible to increase rigidity of a wider region of the circumferential region of each of the left and right tank bands 15.

In particular, in a case in which the second connecting member 20B is installed in the center of the rear side of the tank 10, as in the present embodiment, the rear portion of the tank 10 can be protected by the second connecting member 20B when an impact load is input from a position behind the vehicle, for example.

Furthermore, in the tank holding portion structure of the present embodiment, the second connecting member 20B is formed of a plate-shaped member which substantially conforms to the outer circumferential surface of the tank 10, and the lightening hole 20Ba is formed at a position on the second connecting member 20B which does not overlap the left and right tank bands 15 between the tank bands 15. For this reason, in a case in which the present configuration is adopted, it is possible to increase torsional rigidity of the left and right tank bands 15 while suppressing an increase in weight by the plate-shaped second connecting member 20B having the lightening hole 20Ba.

In addition, in the case of the present configuration, it is possible to maintain rigidity against torsion to be high by the upper side portion and the lower side portion of the plate-shaped second connecting member 20B with the lightening hole 20Ba interposed therebetween. Therefore, torsion of the left and right tank bands 15 can be effectively suppressed.

In addition, the tank holding portion structure of the present embodiment includes the front third connecting member 20C that is fixed to the front cross member 4 (the first vehicle body frame) and the rear third connecting member 20C that is fixed to the rear cross member 5 (the second vehicle body frame). The front and rear third connecting members 20C are connected to portions of the band element pieces 15a, 15b, and 15c of the left and right tank bands 15 other than the connecting ends. For this reason, in a case in which the present configuration is adopted, torsional rigidity of the left and right tank bands 15 can be increased by the front and rear third connecting members 20C, and the tank bands 15 and the tank 10 can be firmly fixed to the front cross member 4 and the rear cross member 5 by the same front and rear third connecting members 20C.

In addition, in the tank holding portion structure of the present embodiment, the connecting portions of the band element pieces 15a, 15b, and 15c each having the spring function component (the guide rod 18 and the compression spring 19) are each disposed above and below the front and rear third connecting members 20C. For this reason, when the tank 10 expands or contracts due to heat or the like, the spring function component (the compression spring 19) expands or contracts at each of sides above and below the front and rear third connecting members 20C fixed to the vehicle body frame (the front cross member 4 and the rear cross member 5). This allows the left and right tank bands 15 to expand or contract more evenly in the circumferential region. As a result, as shown in FIG. 4B, the center point o of the tank 10 is less likely to move significantly up and down. Therefore, in a case in which the present configuration is adopted, it is possible to stably arrange the tank 10 below the floor panel 2.

Furthermore, in the tank holding portion structure of the present embodiment, the first connecting member 20A and the second connecting member 20B are disposed above the center point o of the tank 10 and above the front and rear third connecting members 20C. The first connecting member 20A and the second connecting member 20B (the connecting members other than the third connecting member 20C) are disposed only on the side of the center point o of the tank 10 with respect to the straight line L1 connecting the upper end portions of the band fixing portions 30 of the front and rear third connecting members 20C. In this case, since the front and rear third connecting members are supported by the vehicle body frame (the front cross member 4 and the rear cross member 5) with high rigidity, the supporting rigidity of the tank band 15 at the band fixing portion 30 is also high. In the circumferential region of the tank band 15, a portion on a side of the center point o of the tank 10 has a relatively larger separation distance than a portion on a side opposite to the center point o with respect to the straight line L1. For this reason, in the circumferential region of the tank band 15, torsion is more likely to occur in the region above the straight line L1.

In the present configuration, since the connecting members (the first connecting member 20A and the second connecting member 20B) other than the third connecting member 20C are disposed only on the side on which the separation distance from the straight line L1 connecting the upper end portions of the band fixing portions 30 of the front and rear third connecting members 20C is larger, it is possible to efficiently suppress torsion in a portion of the circumferential region of the tank band 15 in which torsion is likely to occur. Therefore, in a case in which the present configuration is adopted, it is possible to efficiently suppress torsion of the left and right tank bands 15 and the tank 10 while minimizing an increase in weight due to addition of the connecting member.

The present invention is not limited to the above embodiment, and various design changes can be made without departing from the gist thereof. For example, in the above embodiment, two tank bands 15 are provided side by side in the axial direction of the tank 10, but the number of tank bands 15 that are disposed in the circumferential region of the tank 10 is not limited to this. The number of tank bands 15 may be three or more. In this case, it is desirable that the connecting member be connected to all of the tank bands.

In addition, in the above embodiment, the guide rod 18 and the compression spring 19 are used as the spring function component disposed at the connecting portion of the band element pieces 15a, 15b, and 15c, but the configuration of the spring function component is not limited to this. The spring function component may have any structure as long as it can exert a reaction force on the band element pieces 15a, 15b, and 15c when a tensile load acts between the adjacent band element pieces 15a, 15b, and 15c. The spring used in the spring function component is also not limited to a metal coil spring and may be a plate-shaped metal spring, a rubber elastic member, or the like.

Furthermore, in the above embodiment, the left and right tank bands 15 are constituted by three band element pieces 15a, 15b, and 15c, but the number of band element pieces configuring the tank bands 15 is not limited to three. The number of band element pieces may be two or four or more.

In addition, in the above embodiment, the substantially cylindrical tank 10 is disposed below the floor panel 2 of the vehicle such that the axial direction of the tank 10 is aligned with the vehicle width direction, but the arrangement of the tank 10 below the floor panel 2 is not limited to this. The tank 10 may be disposed, for example, such that the axial direction of the tank 10 is to be the front-rear direction of the vehicle or is to be oblique with respect to the vehicle width direction.

### BRIEF DESCRIPTION OF THE REFERENCE SYMBOLS

2: Floor panel
4: Front cross member (first vehicle body frame)
5: Rear cross member (second vehicle body frame)
10: Tank
15: Tank band
15a, 15b, 15c: Band element piece
16: First fixing piece
17: Second fixing piece
18: Guide rod (spring function component)
19: Compression spring (spring function component)
20A: First connecting member (connecting member)
20Aa: Band fixing wall
20Ab: Standing wall
20B: Second connecting member (connecting member)
20Ba: Lightening hole
20C: Third connecting member (connecting member)
30: Band fixing portion
L1: Straight line connecting end portions
o: Center point of tank

1.-10. (canceled)

11. A tank holding portion structure of a vehicle which holds a substantially cylindrical tank disposed below a floor panel of a vehicle body, comprising:
a plurality of tank bands which are disposed at a plurality of locations spaced apart from each other in an axial direction of the tank and each of which restrains an outer circumferential surface of the tank; and
a plurality of connecting members extending in the axial direction of the tank and connecting the adjacent tank bands to each other on an outer circumferential portion of the tank.

12. The tank holding portion structure of a vehicle according to claim 11,
wherein each of the tank bands is formed by connecting a plurality of band element pieces arranged in an outer circumferential direction of the tank in an annular shape, and
wherein the plurality of connecting members include a first connecting member that connects connecting ends of the band element pieces of the adjacent tank bands to each other.

13. The tank holding portion structure of a vehicle according to claim 12,
wherein a connecting portion of the band element pieces includes
a first fixing piece that is fixed to one of the band element pieces,
a second fixing piece that is fixed to the other one of the band element pieces, and
a spring function component that connects the first fixing piece and the second fixing piece with spring elasticity, and
wherein the first connecting member connects at least either the first fixing pieces or the second fixing pieces of the adjacent tank bands in the connecting portions of at least some of the band element pieces.

14. The tank holding portion structure of a vehicle according to claim 13, wherein the first connecting member is formed integrally with at least one of the first fixing piece and the second fixing piece.

15. The tank holding portion structure of a vehicle according to claim 13,
wherein the first connecting member includes
a band fixing wall that is overlapped and fixed to an outer surface of each of the band element pieces of the adjacent tank bands, and
a standing wall that stands up outward from the band fixing wall in a radial direction of the tank, and
wherein the spring function component is connected to the standing wall.

16. The tank holding portion structure of a vehicle according to claim 14,
wherein the first connecting member includes
a band fixing wall that is overlapped and fixed to an outer surface of each of the band element pieces of the adjacent tank bands, and
a standing wall that stands up outward from the band fixing wall in a radial direction of the tank, and
wherein the spring function component is connected to the standing wall.

17. The tank holding portion structure of a vehicle according to claim 13, wherein the plurality of connecting members include a second connecting member that connects portions of the band element pieces of the adjacent tank bands other than the connecting ends to each other.

18. The tank holding portion structure of a vehicle according to claim 17,
wherein the second connecting member is formed of a plate-shaped member which substantially conforms to the outer circumferential surface of the tank, and
wherein a lightening hole is formed at a position on the second connecting member which does not overlap the adjacent tank bands between the tank bands.

19. The tank holding portion structure of a vehicle according to claim 13, wherein the plurality of connecting members include a pair of third connecting members that connect portions of the band element pieces of the adjacent tank bands other than the connecting ends to each other and are each fixed to a first vehicle body frame and a second vehicle body frame which are disposed to be spaced apart from each other in a direction intersecting with the axial direction of the tank.

20. The tank holding portion structure of a vehicle according to claim 19, wherein the connecting portions of the band element pieces each having the spring function component are each disposed above and below the pair of third connecting members.

21. The tank holding portion structure of a vehicle according to claim 19, wherein the connecting members other than the pair of third connecting members are disposed only on a side of a center point of the tank with respect to a straight line connecting end portions of the band fixing portions of the pair of third connecting members in a vertical direction.
